(19) United States
(12) Patent Application Publication
(10) Pub. No.: US 2023/0123002 A1
(43) Pub. Date: Apr. 20, 2023

(54) Engine Oil Pump Drive Shaft And Distributor Alignment Tool

(71) Applicant: Donald Avery, West Windsor, VT (US)

(72) Inventor: Donald Avery, West Windsor, VT (US)

(21) Appl. No.: 17/506,533

(22) Filed: Oct. 20, 2021

(51) Int. Cl. F01M 1/02

(52) U.S. Cl. CPC F01M 1/02; F01M 2001/0276; F01M 2001/0284

(57) ABSTRACT

A tool to facilitate alignment and synchronization of an internal combustion engine oil pump drive shaft and distributor. In a preferred embodiment, the tool is a tubular shaped shaft having cross pieces arranged in both ends of the shaft to facilitate such alignment.

### FIELD OF THE INVENTION

The invention relates to a tool for aligning an engine oil pump drive shaft and a distributor, and methods for making, and methods for using such.

### BACKGROUND OF THE INVENTION

In the assembly, adjustment, and repair of automobile engines and other internal combustion engines, it is sometimes necessary to align the engine oil pump drive shaft and the distributor (e.g., in such small and large block engines made by or for General Motors or Chevrolet, or used in vehicles sold under the brand of General Motors or Chevrolet). In the absence of a specialized tool for performing such an alignment, it can be difficult for the person (especially if they are working alone) to attempt to align the two to obtain the correct alignment. Therefore, a specialized tool for aligning an engine oil pump drive shaft and a distributor is needed and would be beneficial to a person attempting to make the alignment.

### SUMMARY OF THE INVENTION

This invention concerns tools to facilitate alignment of an internal combustion engine oil pump drive shaft and a distributer. In certain of the most preferred embodiments, these tools comprise a tubular shaped shaft or some other shape (e.g., part tubular, part box shape; all tubular; all box shape).

In certain of the most preferred embodiments, each of the tools comprises a first inlet or first end on one end of the tools. The first inlet comprises a first cross piece spanning the diameter or the width of part of the tools wherein the first inlet and the first cross piece are capable of engaging a notch on the engine oil pump drive shaft. The size and shape of the first inlet (or first end) and the first cross piece can vary depending on the make and model of the engine (e.g., GM, Ford, Chrysler).

In these embodiments, each of the tools also comprises a second inlet or second end on the opposite end of the tools. The second inlet comprises a second cross piece spanning the diameter or width of part of the tools wherein the second cross piece and the first cross piece are in the same position (e.g., on the same axis) and thus are capable of indicating to the user the position of the first cross piece and thus the position of the notch on the engine oil pump drive shaft. In the most preferred embodiments, the first cross piece and the second cross piece also are aligned within the tools with one another (i.e., on the same axis so that the second cross piece is a reliable indicator of the position of the first cross piece). Alternative embodiments of the second inlet or second end use paint, notches, protrusions or other indicators of the position of the first cross piece instead of the second cross piece.

In other preferred embodiments, the invention comprises methods of aligning an internal combustion engine oil pump drive shaft and a distributor. In the most preferred embodiments of these methods, the methods comprise placing a first inlet on one end of tools onto the engine oil pump drive shaft. The methods then comprise observing a second inlet on an opposite end of the tools to determine the placement of the first cross piece and thus the position of the engine oil pump drive shaft. It should be noted that these last two steps can be done in any order and after they are done, the tools have aligned the engine oil pump drive shaft with the distributor.

In certain of the most preferred embodiments of the methods of aligning, the first inlet of the tool comprises a first cross piece spanning the diameter or width of part of the tools and the first inlet is capable of engaging the engine oil pump drive shaft. In these embodiments, the second inlet comprises a second cross piece spanning the diameter or width of part of the tools and the second inlet is capable of indicating the position of the first cross piece and thus the position of the notch on the engine oil pump drive shaft.

In other preferred embodiments, the invention comprises methods of making a tool for aligning an engine oil pump drive shaft and a distributor of an internal combustion engine. In the most preferred embodiments of these methods, the methods comprise cutting or otherwise obtaining (e.g., forging, rolling, grinding, lathing, and other methods) a tubular shaped shaft or other shape that is of a length that is capable of engaging an engine oil pump drive shaft on the one end and being observable by the user on the opposite end at the same time. In the most preferred embodiments of these methods, a step is performed that comprises installing (e.g., welding, forging, bolting, screwing, gluing, cutting out, lathing, machining, and other methods) a first cross piece spanning the diameter or width of part of the tubular shaped shaft (or other shape) on the one end of the tubular shaped shaft (or other shape) and another step of installing (e.g., welding, forging, bolting, screwing, gluing, cutting out, lathing, machining, and other methods) a second cross piece spanning the diameter or width of part of the tubular shaped shaft (or other shape) on the opposite end of the tubular shaped shaft (or other shape). It should be noted that these latter two steps can be done in any order. The first cross piece and the second cross piece are installed so that they are aligned with one another within the tubular shaped shaft (or other shape).

In some embodiments, the first and/or second cross pieces can be added (e.g., welded on) to a tubular shaped shaft (or other shape) to make tool embodiments of this invention. In other embodiments, instead of adding the first and/or second cross pieces, they are formed by removing material (e.g., cutting out, machining) from a solid or partially solid end or ends of the tubular shaped shaft (or other shape) to make tool embodiments of this invention.

In the most preferred embodiments, the tools, the methods of using, and the methods of making are used with the internal combustion engines (e.g., small and large block) that are manufactured for or by General Motors or Chevrolet and/or are used in General Motors or Chevrolet brand vehicles. In other embodiments, the tools, the methods of using, and the methods of making are used with the internal combustion engines that are manufactured for or by other companies, such as Ford, Chrysler, and other manufacturers. In other preferred embodiments, a kit is provided that can provide two or more removable first ends that each fit a different make and model of engine or type of engine.

### BRIEF DESCRIPTION OF THE DRAWINGS

FIG. 1 is a side view of an embodiment of a tool of this invention.

FIG. 2 is a view of the first end of an embodiment of a tool of this invention.

FIG. 3 is a view of the second (opposite to first end) end view of an embodiment of a tool of this invention.

### DETAILED DESCRIPTION OF THE INVENTION

The invention comprises tools to facilitate alignment and synchronization of an internal combustion engine oil pump drive shaft and distributor. In a preferred embodiment, the tool is a tubular shaped shaft having cross pieces arranged (e.g., welded) in both ends of the shaft to facilitate such alignment. The invention solves decades old and cumbersome problems for auto mechanics throughout the world. The invention provides embodiments of a tool that is capable of aligning and synchronizing oil pump drive shafts with distributors. In preferred embodiments, the tool can be used with, for example, General Motor V-8 engines and align the oil pump draft shaft with the distributor quickly (e.g., less than one minute) without the need for assistants, mirrors, cameras, screwdrivers, or hacksaw blades. In preferred embodiments, the tool does not require two people to turn an engine, with one person bump starting the engine while the other person holds the distributor in place to keep the rotor pointing to the number one cylinder in the firing order.

In the most preferred embodiments, the tool also has an indicator on the top (i.e., second inlet or second end) to show the user the position of the notch or slot in the oil pump drive shaft during installation. The tool is not, however, an oil pump primer.

The preferred embodiments of the tools of this invention are easy to use and easy to store in a toolbox. In the most preferred embodiments, they are relatively inexpensive to make and are not hazardous to use or transport.

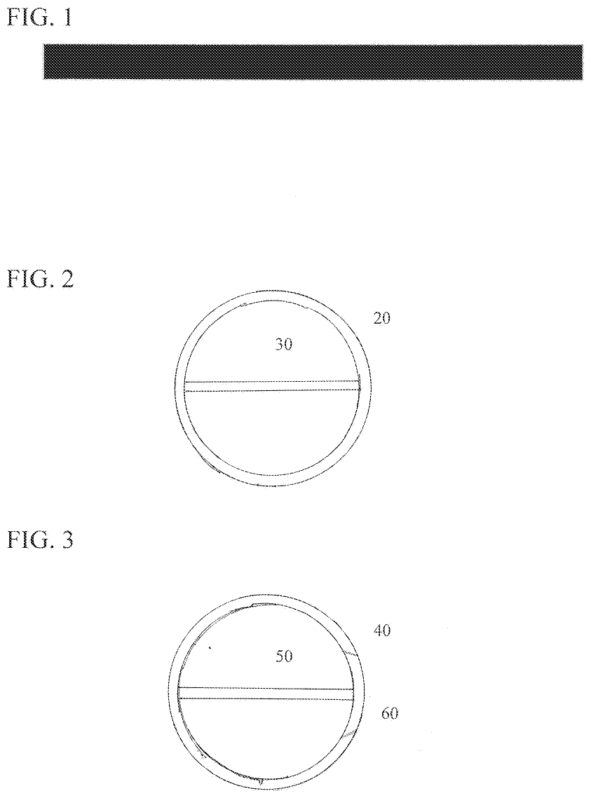

FIG. 1 is a side view of an embodiment of a tool of this invention. In the preferred embodiments, the tools comprise a tubular shape shaft 10 that is about 12 inches long, with an outside diameter of about 1 inch, and an inside diameter of about ⅞ of an inch. Other sizes and shapes can be used for the length of the tool, including solid cylinders, box shape steel, threaded rod, etc.

FIG. 2 is a view of the first end 20 of an embodiment of a tool of this invention. This first end 20 is the end that engages the oil pump drive shaft when the tool is used. In the preferred embodiments, a first cross piece 30 spans the diameter or the width of the tool and it engages the oil pump drive shaft notch or slot. Other sizes and shapes can be used for different makes and models of engines. In preferred embodiments, the first end is removable and it can be replaced with a different first end that fits a different make and model of engine.

FIG. 3 is a view of the second (opposite to first end) end 40 view of an embodiment of a tool of this invention. In the preferred embodiments, a second cross piece 50 spans the diameter or the width of the tool. The second cross piece 50 is in the same position (e.g., in the same axis) in the tool as the first cross piece 30 and it thus indicates to the user the position of the first cross piece 30. In alternative embodiments, instead of a second cross piece, the tool is notched, painted or it otherwise indicates the position of the first cross piece to the user.

In the embodiment shown in FIG. 3, the second cross piece is recessed ⅛ of an inch into the tubular shape shaft 10 and is painted white (or some other color). A portion 60 of the second end 40 of the tubular shape shaft 10 is also painted white (or some other color) so that, in this embodiment, the painted portions of the tool take the approximate form of an arrow that points to the position of the first cylinder with respect to the distributor.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

An embodiment of the tool of this invention was made and successfully used to align the engine oil pump drive shaft of a small block Chevrolet engine with a distributor. A steel pipe, conduit, or tubing was used for the tubular shape shaft. It was about 12 inches long, with an outside diameter of about 1 inch, an inside diameter of about ⅞ of an inch, and a wall thickness of about 1/16 of an inch. Welded into the first end of the pipe was a piece of metal (e.g., a slug) that was about ⅛ of an inch thick and about ⅞ of an inch wide to form the first cross piece. Welded into the second (opposite to the first end) end of the pipe, in the same axis as the first cross piece, was a second piece of metal (e.g., a slug) that was about ⅛ of an inch thick and about ⅞ of an inch wide to form the second cross piece. This second cross piece was recessed into the pipe about ⅛ of an inch and painted white. A portion of the second end of the pipe 60 was also painted white (as was the second cross piece), to form the shape of an arrow as shown in FIG. 3. The tool was then complete.

### Example 2

First, the harmonic balancer should be on top dead center on the compression stroke before alignment. Then, the first end of the tool made in Example 1 was placed over the engine oil pump drive shaft of a Chevrolet engine and the first cross piece engaged the notch or slot on the engine oil pump drive shaft. The user could look at the second cross piece on the second end of the tool to determine the position of the first cross piece, which points to the number one cylinder, and thereby use the tool to align the engine oil pump drive shaft with the distributor.

### Example 3

In this embodiment of the invention, a kit is provided that comprises a tubular shape shaft with two or more removable first ends that each fit the oil pump drive shafts of a different make and model of engine (e.g., one for GM engines, one for Ford engines, one for Chrysler engines). The two or more removable first ends each can have a different diameter and/or shape of the first end, and/or a different size and/or shape of the first cross piece of the first end, and/or other differences known to a person of skill in the art, to each fit a different make and model of engine. The second end and the second cross piece indicates the position of the particular first end and first cross piece that is being used.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A tool to facilitate alignment of an internal combustion engine oil pump drive shaft and a distributer, the tool comprising a first end and a second end, the tool further comprising:
(a) a first inlet on the first end of the tool, the first inlet comprising a first cross piece spanning the width of the tool, the first inlet and the first cross piece capable of engaging the engine oil pump drive shaft; and
(b) a second inlet on the second end of the tool, the second inlet comprising a second cross piece spanning the width of the tubular shaped shaft, the second inlet and the second cross piece capable of indicating the position of the first cross piece;
(c) wherein the first cross piece and the second cross piece are aligned with one another in the same axis.

2. The tool of claim 1, wherein the internal combustion engine is manufactured for or by General Motors or Chevrolet and/or is used in General Motors or Chevrolet brand vehicles.

3. A method of aligning an internal combustion engine oil pump drive shaft and a distributor, the method comprising:
(a) placing a first end of a tool onto the engine oil pump drive shaft;
(b) observing a second end of the tool; and
(c) whereby the second end of the tool indicates the position of the first end of the tool and is used to align the engine oil pump drive shaft with the distributor.

4. The method of claim 3,
(a) the first end of the tool comprising a first cross piece spanning the width of the tool, the first cross piece being capable of engaging a notch on the engine oil pump drive shaft; and
(b) the second end of the tool comprising a second cross piece spanning the width of the tool, the second cross piece providing the indication of the position of the first cross piece.

5. The method of claim 3, wherein the internal combustion engine is manufactured for or by General Motors or Chevrolet and/or is used in General Motors or Chevrolet brand vehicles.

6. A method of making a tool for aligning an engine oil pump drive shaft and a distributor of an internal combustion engine, the method comprising:
(a) cutting or otherwise obtaining a tubular shaped shaft that is of a length that is capable of engaging an engine oil pump drive shaft on the one end and being observed by a user on the opposite end at the same time;
(b) installing a first cross piece spanning the width of the tubular shaped shaft on the one end of the tubular shaped shaft;
(c) installing a second cross piece spanning the width of the tubular shaped shaft on the opposite end of the tubular shaped shaft; and
(d) wherein the first cross piece and the second cross piece are aligned with one another within the tubular shaped shaft.

7. The method of claim 6, wherein the internal combustion engine is manufactured for or by General Motors or Chevrolet and/or is used in General Motors or Chevrolet brand vehicles.
